(19) United States
(12) Patent Application Publication
(10) Pub. No.: US 2026/0058365 A1
(43) Pub. Date: Feb. 26, 2026

(54) META STRUCTURE WITH GAP MODE

(71) Applicant: ELECTRONICS AND TELECOMMUNICATIONS RESEARCH INSTITUTE, Daejeon (KR)

(72) Inventors: Yong Hae KIM, Daejeon (KR); Chi Sun HWANG, Daejeon (KR); Jae Hyun MOON, Daejeon (KR); Jong Heon YANG, Daejeon (KR); Kyung Hee CHOI, Daejeon (KR); Ji Hun CHOI, Daejeon (KR); Jae Eun PI, Daejeon (KR)

(73) Assignee: ELECTRONICS AND TELECOMMUNICATIONS RESEARCH INSTITUTE, Daejeon (KR)

(21) Appl. No.: 19/302,410

(22) Filed: Aug. 18, 2025

(30) Foreign Application Priority Data
Aug. 21, 2024 (KR) 10-2024-0112146

(51) Int. Cl. H01Q 3/44

(52) U.S. Cl. CPC H01Q 3/44

(57) ABSTRACT

The present disclosure relates to a meta-structure using a gap mode. According to an aspect of the present disclosure, there is provided a meta-structure including: a bottom electrode; an insulating layer on the bottom electrode; antenna electrodes on the insulating layer; a liquid crystal layer on the antenna electrodes and the insulating layer; and a top electrode on the liquid crystal layer.

### CROSS-REFERENCE TO RELATED APPLICATION

The present application claims priority to Patent Application No. 10-2024-0112146, filed on in Korea Intellectual Property Office on Aug. 21, 2024, the entire contents of which are incorporated herein by reference.

### TECHNICAL FIELD

The present disclosure relates to a meta-structure using a gap mode.

### BACKGROUND

The description described below merely provides background information related to this embodiment, and does not constitute the related art.

There are generally not many meta-structures that actively modulate at visible wavelengths. When an ITO electrode was used, the electrode was operated in the near-infrared region, and when a Graphene electrode was used, it was operated in the mid-infrared range. It has recently been reported that metals and dielectrics may be stacked to adjust the ENZ (Epsilon-near-zero) frequency at which the effective permittivity is zero. Assuming that the thicknesses of the metal and the dielectric are sufficiently thin, the effective dielectric constant is expressed by the mean field theory as follows. If the metal and ITO follow the Drude model, the effective refractive index may decrease.

However, in a meta-structure using a liquid crystal and ITO, a high electric field is required in order to exhibit a modulation characteristic by ITO, and a phenomenon in which an ITO thin film is broken often occurs, and there is a problem in that the structure is unstable.

### SUMMARY

An object of the present disclosure is to invent a device having high complex modulation efficiency by combining only a gap mode and a liquid crystal structure in order to prevent destruction of an element due to an electric field.

The problems to be solved by the present invention are not limited to the above-mentioned problems, and other problems that are not mentioned will be clearly understood by those skilled in the art from the following description.

According to an aspect of the present disclosure, there is provided a meta-structure including: a bottom electrode; an insulating layer on the bottom electrode; antenna electrodes on the insulating layer; a liquid crystal layer on the antenna electrodes and the insulating layer; and a top electrode on the liquid crystal layer.

According to an embodiment of the present disclosure, the complex modulation efficiency may be increased by combining only the gap mode and the liquid crystal structure to prevent destruction of the device due to an electric field.

According to an embodiment of the present disclosure, a meta-structure using a liquid crystal and a gap mode may be used to be applied to a Spatial Light Modulator (SLM) of a future holographic display.

The effects of the present disclosure are not limited to the above-mentioned effects, and other effects that are not mentioned will be clearly understood by those skilled in the art from the following description.

### BRIEF DESCRIPTION OF THE DRAWINGS

FIG. 1 is a diagram illustrating a meta-structure using a gap mode according to an embodiment of the present disclosure.

FIG. 2 is a diagram illustrating complex modulation characteristics by a meta-structure, according to an embodiment of the present disclosure.

FIGS. 3A and 3B are diagrams illustrating complex modulation characteristics in outphase according to an embodiment of the present disclosure.

FIGS. 4A and 4B are diagrams illustrating complex modulation characteristics in inphase according to an embodiment of the present disclosure.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing components of embodiments of the present disclosure, reference numerals such as first, second, i), ii), and a), b) may be used. These numerals are only used to distinguish the components from other components, and the nature, sequence, order, or the like of the components is not limited by the numerals. In the specification, when a part “includes” or “comprises” a component, unless there is an explicit description to the contrary, the part may further include other components rather than excluding the other components.

The detailed description set forth below in connection with the appended drawings is intended to describe exemplary embodiments of the disclosure and is not intended to represent the only embodiment in which the disclosure may be practiced.

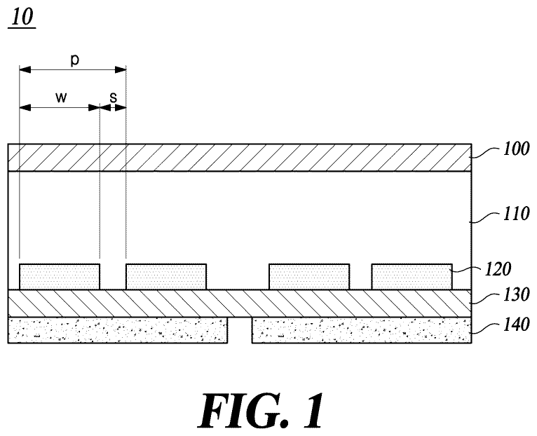

FIG. 1 is a diagram illustrating a meta-structure 10 using a gap mode according to an embodiment of the present disclosure.

The meta-structure 10 using the gap mode according to an embodiment of the present disclosure may include all or some of the top electrode 100, the liquid crystal layer 110, the antenna electrodes 120, the insulating layer 130, and the bottom electrode 140.

Gap mode refers to resonance phenomenon that occurs in the gap between the antenna and the metal. This resonance phenomenon has a high electric field due to the concentration of electromagnetic energy at a specific frequency. The Gap mode is represented by the antenna electrodes 120-insulating layer 130-bottom electrode 140 structure. The resonant frequency of the gap mode may be changed by adjusting the thickness of the insulating layer 130. When the thickness of the insulating layer increases, the path length of the electromagnetic wave in the gap increases, and thus the resonance frequency decreases. When the thickness of the insulating layer decreases, the path length of the electromagnetic wave decreases, and the resonance frequency increases.

The top electrode 100 may be provided on the liquid crystal layer 110. The top electrode 100 may include ITO glass. The ITO glass may cover the liquid crystal layer 110. The top electrode 100 is coated with polyimide and then subjected to a rubbing process. The rubbing direction is perpendicular to the antenna electrodes 120, such that the liquid crystal structure forms a Twisted Nematic (TN) structure.

The liquid crystal layer 110 may be provided on the antenna electrodes 120 and the insulating layer 130. The liquid crystal structure should use a TN structure. The TN structure is a structure generally used in the field of liquid crystal displays, and has a configuration in which the arrangement of liquid crystal molecules is twisted by 90 degrees. This structure has a property of allowing light to pass through in a specific manner in a state where no voltage is applied, and changing the arrangement of liquid crystal molecules to block or otherwise deform the passage of light when a voltage is applied. The TN structure may basically be configured in such a way that a liquid crystal layer is sandwiched between two glass substrates.

The antenna electrodes 120 may be provided on the insulating layer 130. The antenna electrodes 120 should use a material from which a natural oxide film is formed. The antenna electrodes 120 may contain aluminum (Al), molybdenum (Mo), or titanium-tungsten (TiW). The antenna electrodes 120 is a rod-like structure, and may be an elongated rod having a rectangular cross-section.

The insulating layer 130 may be provided on the bottom electrode 140. The insulating layer 130 may include a dielectric. For example, the insulating layer 130 may contain aluminum oxide (Al2 O3). According to the present disclosure, aluminum oxide is used as the insulating layer 130 between the antenna electrodes 120 and the bottom electrode 140 to form a gap mode. In the visible light region, the thickness of the insulating layer 130 is 10 nm to 20 nm. It is necessary to check the liquid crystal anchoring characteristics of the antenna electrodes 120 and the insulating layer 130. This is because there is a constraint that polyimide coating cannot be applied due to the thin thickness of the antenna electrodes (120). Therefore, the present disclosure relates to the case where both the antenna electrodes 120 and the insulating layer 130 have a property of orienting the liquid crystal layer 110 in parallel. Even when another insulator is used for the insulating layer 130 instead of aluminum oxide, it is included in the present disclosure as long as the alignment of the liquid crystal layer 110 is parallel.

The bottom electrode 140 may be provided below the insulating layer 130. The bottom electrode 140 may contain gold (Au), silver (Ag), copper (Cu), aluminum (Al), ITO, or TiW, and the present disclosure is not limited thereto.

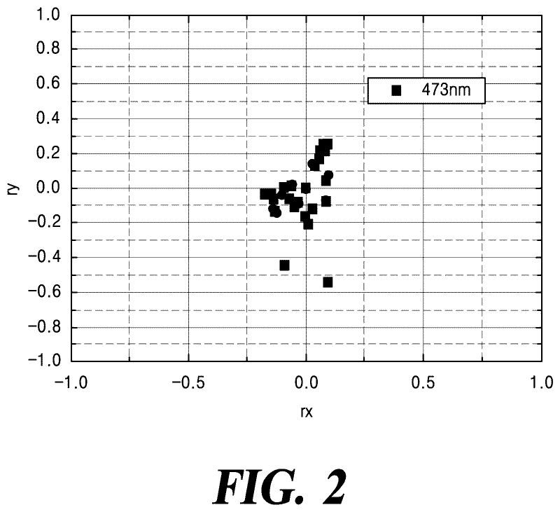

FIG. 2 is a diagram illustrating complex modulation characteristics by a meta-structure 10, according to an embodiment of the present disclosure.

FIG. 2 is a diagram showing complex modulation characteristics in a visible light region.

The antenna electrodes 120 contain aluminum (Al), and each antenna electrodes 120 is arranged at a spacing of 150 nm. In addition, the antenna electrodes 120 correspond to a width of 70 nm. The insulating layer 130 contains aluminum oxide. The thickness of the insulating layer 130 is 10 nm to 20 nm. The anisotropy of the liquid crystal layer 110 is 0.19. The bottom electrode 140 contains TiW. From the center (0,0), when the distribution diagram is formed evenly and shows a shape similar to a circle, it may be proved that complex modulation is possible.

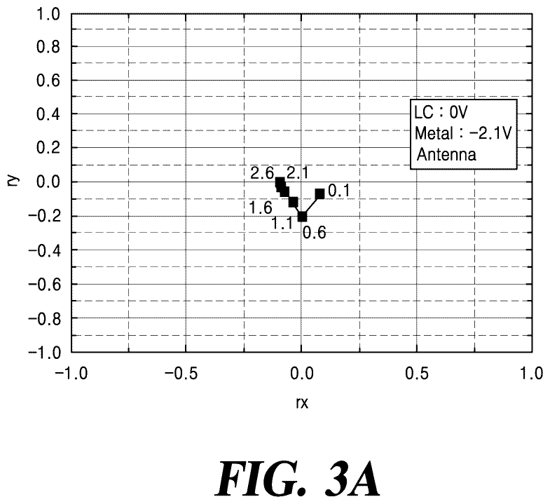

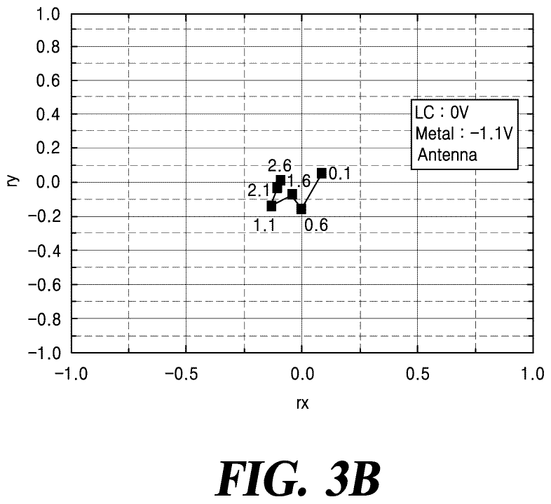

FIGS. 3A and 3B are diagrams illustrating complex modulation characteristics in outphase according to an embodiment of the present disclosure.

Referring to FIGS. 3A and 3B, rx and ry denote real and imaginary values of the complex reflection coefficient r.

The liquid crystal layer 110 operates regardless of the voltage polarity. The arrangement of the liquid crystal layer 110 varies depending on the magnitude of the voltage. Irrespective of the polarity of the voltage, when a voltage is applied, the liquid crystal molecules may rearrange and change the polarization state of light. It is used to control the properties of light in an optical device. However, the gap mode reacts sensitively to the voltage direction. Therefore, in order to widen the complex modulation region, it is necessary to consider both a case where the phases of the voltage applied to the antenna electrodes 120 and the AC voltage applied to the bottom electrode 140 are outphased and a case where they are inphased. Here, “outphase” means the case where the phases of the voltage applied to the antenna electrodes 120 and the AC voltage applied to the bottom electrode 140 are opposite to each other, and “inphase” means the case of the same phase.

Widening the complex modulation region means expanding the control range of complex modulation. This allows for a wider range of phase and amplitude variations in various frequency bands, allowing for more complex and varied modulation of light. In order to widen the complex modulation region, it is necessary to increase the refractive index anisotropy of the liquid crystal layer 110 or to improve the reflectivity of the antenna electrodes 120.

FIG. 3A is a diagram illustrating complex modulation characteristics in outphase when the voltage of the liquid crystal layer 110 is 0 V and the voltage of the bottom electrode 140 is −2.1 V.

Referring to FIG. 3A, when voltages applied to the antenna electrodes 120 and the bottom electrode 140 are outphase, complex modulation characteristics are shown. When the distribution diagram tends to be formed evenly from the center point (0, 0), it is understood that complex modulation is possible.

FIG. 3B is a diagram illustrating complex modulation characteristics in outphase when the voltage of the liquid crystal layer 110 is 0 V and the voltage of the bottom electrode 140 is −1.1 V.

Referring to FIG. 3B, when voltages applied to the antenna electrodes 120 and the bottom electrode 140 are inphase, complex modulation characteristics are shown. When the distribution diagram tends to be formed evenly from the center point (0, 0), it is understood that complex modulation is possible.

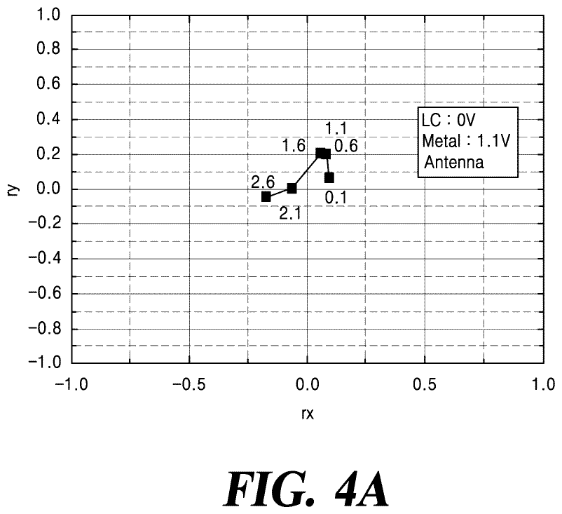

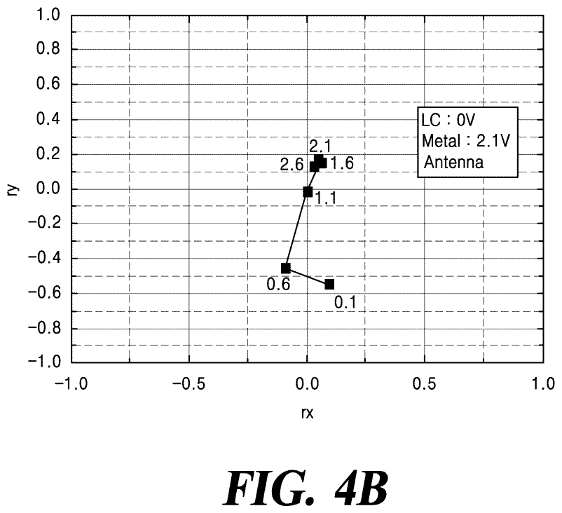

FIGS. 4A and 4B are diagrams illustrating complex modulation characteristics in inphase according to an embodiment of the present disclosure.

Referring to FIGS. 4A and 4B, rx and ry denote real and imaginary values of the complex reflection coefficient r.

FIG. 4A is a diagram illustrating complex modulation characteristics in outphase when the voltage of the liquid crystal layer 110 is 0 V and the voltage of the bottom electrode 140 is 1.1 V.

In comparison with FIGS. 3A and 3B, it may be determined that the complex modulation efficiency is relatively poor, considering that the distribution diagram is somewhat distant from the center point (0, 0).

FIG. 4B is a diagram illustrating complex modulation characteristics in outphase when the voltage of the liquid crystal layer 110 is 0 V and the voltage of the bottom electrode 140 is 2.1 V.

In comparison with FIGS. 3A and 3B, it may be determined that the complex modulation efficiency is relatively poor, considering that the distribution diagram is relatively distant from the center point (0, 0).

Thus, the voltage phase condition in outphase has higher complex modulation efficiency than in inphase.

At least some of the components described in the exemplary embodiments of the present disclosure may be implemented as hardware components including at least one or a combination of a digital signal processor (DSP), a processor, a controller, an application-specific IC (ASIC), a programmable logic device (FPGA, etc.), and other electronic devices. In addition, at least some functions or processes described in the exemplary embodiments may be implemented in software, and the software may be stored in a recording medium. At least some components, functions, and processes described in the exemplary embodiments of the present disclosure may be implemented by a combination of hardware and software.

The method according to the exemplary embodiments of the present disclosure may be written as a computer-executable program, and may also be implemented as various recording media such as a magnetic storage medium, an optical reading medium, and a digital storage medium.

Implementations of the various techniques described herein may be implemented in digital electronic circuitry, or in computer hardware, firmware, software, or in combinations thereof. Implementations may be implemented as a computer program product, i.e., a computer program tangibly embodied in an information carrier, for example, in a machine-readable storage device (computer-readable medium) or in a propagated signal, for processing by, or to control the operation of, data processing apparatus, e.g., a programmable processor, a computer, or multiple computers. A computer program, such as the computer program(s) described above, may be written in any form of programming language, including compiled or interpreted languages, and it may be deployed in any form, including as a stand-alone program or as a module, component, subroutine, or other unit suitable for use in a computing environment. A computer program may be deployed to be processed on one computer or on multiple computers at one site or distributed across multiple sites and interconnected by a communication network.

Processors suitable for the processing of a computer program include, by way of example, both general and special purpose microprocessors, and any one or more processors of any kind of digital computer. Generally, a processor will receive instructions and data from a read-only memory or a random-access memory or both. Elements of a computer may include at least one processor for executing instructions and one or more memory devices for storing instructions and data. Generally, a computer may include one or more mass storage devices for storing data, such as magnetic disks, magneto-optical disks, or optical disks, or may be coupled to receive data from, transmit data to, or both. Information carriers suitable for embodying computer program instructions and data include, by way of example, semiconductor memory devices, magnetic media such as hard disks, floppy disks, and magnetic tape, optical media such as Compact Disk Read Only Memory (CD-ROM), Digital Video Disk (DVD), Magneto-Optical Media such as Floptical Disk, Read Only Memory (ROM), Random Access Memory (RAM), flash memory, Erasable Programmable ROM (EPROM), Electrically Erasable Programmable ROM (EEPROM), and the like. The processor and the memory may be supplemented by, or incorporated in, special purpose logic circuitry.

The processor may perform an operating system and a software application performed on the operating system. Further, the processor device may access, store, manipulate, process, and generate data in response to execution of the software. For ease of understanding, a processor device may be described as being used singly, but a person skilled in the art may understand that the processor device may include a plurality of processing elements and/or a plurality of types of processing elements. For example, the processor device may include a plurality of processors or one processor and one controller. Other processing configurations are also possible, such as parallel processors.

Moreover, non-transitory computer-readable media may be any available media that may be accessed by a computer and includes both computer storage media and transmission media.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described as operating in certain combinations and even initially claimed as such, one or more features from a claimed combination may in some cases be excised from the combination, and the claimed combination may be modified to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain cases, multitasking and parallel processing may be advantageous. Moreover, the separation of various device components in the embodiments described above should not be understood as requiring such separation in all embodiments, and it should be understood that the described program components and devices may generally be integrated together in a single software product or packaged into multiple software products.

Meanwhile, it should be noted that the embodiments of the present disclosure disclosed in the specification and the drawings are merely specific examples for facilitating understanding, and are not intended to limit the scope of the present disclosure. It is obvious to a person skilled in the art that other variations based on the technical idea of the present invention may be implemented in addition to the embodiments disclosed herein.

The protection scope of the present embodiment is to be construed according to the following claims, and all technical ideas within the scope equivalent thereto are construed as being included in the scope of rights of the present embodiment.

What is claimed is:

1. A meta-structure, comprising:
a bottom electrode;
an insulating layer on the bottom electrode;
antenna electrodes on the insulating layer;
a liquid crystal layer on the antenna electrodes and the insulating layer; and
a top electrode on the liquid crystal layer.

2. The meta-structure of claim 1, wherein the structure formed by the antenna electrodes, the insulating layer, and the bottom electrode is a gap mode.

3. The meta-structure of claim 1, wherein the top electrode comprises ITO glass.

4. The meta-structure of claim 3, wherein the ITO glass is subjected to polyimide coating and rubbing treatment.

5. The meta-structure of claim 4, characterized in that the rubbing direction is perpendicular to a direction of the antenna electrodes.

6. The meta-structure of claim 1, wherein the insulating layer comprises aluminum oxide (Al2O3).

7. The meta-structure of claim 1, wherein the insulating layer has a thickness of 10 nm to 20 nm.

8. The meta-structure of claim 1, wherein the antenna electrodes comprise aluminum (Al), molybdenum (Mo), or titanium-tungsten (TiW).

9. The meta-structure of claim 1, wherein the bottom electrode is any one of gold, silver, copper, aluminum, ITO, or TiW.

10. The meta-structure of claim 1, wherein both the antenna electrodes and the insulating layer are oriented parallel to the liquid crystal layer.

11. A method of manufacturing a meta-structure, comprising:
preparing a bottom electrode;
forming an insulating layer on the bottom electrode;
forming antenna electrodes on the insulating layer;
forming a liquid crystal layer on the antenna electrodes and the insulating layer; and
forming a top electrode on the liquid crystal layer.

12. The method of claim 11, wherein the structure formed by the antenna electrodes, the insulating layer, and the bottom electrode is a gap mode.

13. The method of claim 11, wherein the top electrode comprises ITO glass.

14. The method of claim 13, wherein the ITO glass is subjected to polyimide coating and rubbing treatment.

15. The method of claim 14, characterized in that the rubbing direction is perpendicular to a direction of the antenna electrodes.

16. The method of claim 11, wherein the insulating layer comprises aluminum oxide (Al2O3).

17. The method of claim 11, wherein the insulating layer has a thickness of 10 nm to 20 nm.

18. The method of claim 11, wherein the antenna electrodes comprise aluminum (Al), molybdenum (Mo), or titanium-tungsten (TiW).

19. The method of claim 11, wherein the bottom electrode is any one of gold, silver, copper, aluminum, ITO, or TiW.

20. The method of claim 11, wherein both the antenna electrodes and the insulating layer are oriented parallel to the liquid crystal layer.
